(19) United States
(12) Patent Application Publication
(10) Pub. No.: US 2007/0198651 A1
(43) Pub. Date: Aug. 23, 2007

(54) Automatic Internet Access System

(76) Inventor: Lawrence P. O'Daly, Ocean Ridge, FL (US)

Correspondence Address: JOHN C. SMITH, ESQ., 2499 GLADES ROAD, SUITE 113, BOCA RATON, FL, 33431, US

(21) Appl. No.: 11/307,766

(22) Filed: Feb. 21, 2006

(51) Int. Cl. G06F 15/16

(52) U.S. Cl. 709/217

(57) ABSTRACT

A data delivery engine with a custom programmed disc with differing Internet addressing capabilities which allows any computer user to automatically access and receive a wide range of predetermined streaming audio and video content from a multimedia server. In the preferred embodiment, the disc comes with an autorun feature that automatically accesses the Internet when loaded. It accesses a remote server which delivers streaming video to the user's computer. The streaming video can be delivered and screened one time and then automatically erased and discarded (i.e. one time use), or alternatively, saved to the receiving computer's hard drive for future access and playback thereafter.

### BACKGROUND OF THE INVENTION

1. Technical Field

The system disclosed herein is a data delivery engine that automatically accesses the Internet and downloads information from a pre-selected pool of information. The data delivery engine may download one or more items of information at predetermined time intervals for use by a local computer, or download large blocks of information which are divided into smaller portions by the local computer of which are then accessed and used by the local computer.

2. Background of the invention

A variety of products have been used to provide information over a period of time. For example, paper “Word-a-Day” calendars have been used to teach vocabulary to individuals. Likewise, a variety of calendars have provided a different amusing saying, joke, or drawing each day. While these products are useful for providing entertainment or educational information to individuals, they are limited by the media they use and cannot be dynamically used to present information independent of user action. Nor can they be dynamically updated over time.

Another drawback to these products is that they are typically limited to one type of subject matter. It would be advantageous to have a system which allows a variety of information types that can be distributed on demand to a wide range of users.

Yet another disadvantage of the aforementioned prior art is that it is typically limited to the print media, and does not take advantage of more sophisticated media, such as audio, video, or audio/video (A/V streaming.) It would be desirable to have a system which can dynamically select and present portions of a pool of information to an individual which contains one or more types of data.

While the prior art has provided a fixed set of information that is provided in hard copy form. It has failed to provide a system that can dynamically access information, which can obtain a variety of subject matter, and which can be dynamically presented to a user without any effort on the user's part.

### SUMMARY OF THE INVENTION

The data delivery engine is an information delivery system which automatically downloads information from the Internet and displays at least a portion of the information at predetermined times to a computer user. The data delivery engine uses a disc, such as a CD, mini-CD, DVD, or mini-DVD disc, magnetic disk, solid-state device, flash memory, or any other suitable storage technology. For ease of discussion, any such storage device, whether or not it is an optical storage device, will be referred to herein as a disc. The disc includes software which is custom programmed with differing Internet URL addressing capabilities which allows any computer user worldwide to automatically access and receive a wide range of predetermined streaming audio and video content from a multimedia server. In the preferred embodiment, the data delivery engine automatically accesses the Internet when loaded. Once loaded, it accesses a remote Internet server which delivers streaming video to the user's computer. The streaming video can be downloaded and displayed a single time and then automatically erased and discarded (i.e. a one time use). Alternatively, the data can be saved to the receiving computer's hard drive, or other storage, for future access and playback thereafter. In the event that data is stored for future use, the data delivery engine can download multiple information items one time, and play individual items back at predetermined times. In one preferred embodiment, the program that controls the data delivery engine is installed permanently in the computer. This provides the convenience of having the data delivery engine available for downloading information without having to have the disc in the computer.

### BRIEF DESCRIPTION OF THE DRAWINGS

FIG. 1 illustrates a conventional disc storage device.

FIG. 2 illustrates a novelty storage device which has a gear shape.

FIG. 3 illustrates an embodiment of the data delivery engine which downloads one item of information per day.

FIG. 4 illustrates another embodiment of the data delivery engine that downloads an entire month's worth of data at a time.

FIG. 5 illustrates another embodiment of the data delivery engine that downloads data from a plurality of remote server sites.

### DESCRIPTION OF THE PREFERRED EMBODIMENT

Prior to a detailed discussion of the features and advantages of the system, a general overview will be presented. In a preferred embodiment, the data delivery engine is programmed to activate a remote streaming media site which delivers pre-determined data, images, audio files, audio/video files, or streaming video content each time the data delivery engine is activated. Those skilled in the art will recognize that while the invention can be implemented using any computer network, the preferred embodiment envisions the Internet as the primary data transfer mechanism.

The data delivery engine is not a web browser. It is intended to be used as a mechanism to download and distribute information with minimal skill or effort by the user. In its preferred embodiment, the user merely inserts the disc into the system. The data delivery engine preferably has an AutoRun feature which allows the data delivery engine to automatically install itself and begin execution. The advantage of having a system which does not require effort, or computer expertise, on the part of a user means that the data delivery engine can be used by anyone.

The data delivery engine can be used in combination with a variety of information categories. For example, the data delivery engine can be programmed to automatically download a humorous information item such as a quote, a picture, a song, an audio/video file, etc. An advantage of the system is that it allows a wide variety of data types to be used alone, or in combination, for the purpose of distributing information. The information can be entertaining, humorous, scientific, political, educational, etc. There is no limit to the type of data which can be disseminated using the data delivery engine.

Information, such as humorous information or jokes, can be frequently updated at the remote system to ensure that the user is always provided with new information. The system can be programmed to present the humorous information when the system is started, at periodic time intervals, at system shutdown, or when requested by a user. As noted above, those skilled in the art will recognize that humorous information is only one category of data that can be used by the data delivery engine. For example, the data delivery engine is an excellent means of providing educational information. It can be used to improve an individual's vocabulary, to teach words in a foreign language, to teach science facts, historical facts, etc. In fact, there is almost no field of education which could not take advantage of a system which would periodically pose questions or present information to an individual.

Another preferred embodiment provides for a personalized category of data in which the data delivery engine provides personalized messages to individuals. In this embodiment, a sender uploads data to the remote server system. The uploaded data can be a voice message, a picture, an audio/video file, etc. The remote server system uses this data to produce a set of information unique to a particular recipient. The data delivery engine would download the data and present unique messages on important days to that particular recipient. The unique messages could be birthday greetings, anniversary greetings, etc. As was the case above, the messages can take any data format, such as text messages, images, audio/video data, or combinations thereof. While this type of personalized message would be enjoyable by an individual, there are situations in which it may prove especially valuable. For example, for military personnel stationed in foreign countries, and especially in combat zones, the ability to receive personalized messages from loved ones may help to improve soldier morale.

As can be seen, there is no limit to the type of information which can be used by the data delivery engine. The data presented is limited only by the imagination and interests of the individuals who use the data delivery engine.

In one preferred embodiment, the data delivery engine can also be designed to download internet address data directly to the user's hard drive for subsequent continuous, auto repetitive, accessing of a data delivery engine server site. Alternatively, the data delivery engine can be programmed to download multiple Internet addresses and access data from multiple sites. Each of these sites may contain jokes or humorous information, or alternatively, each site may contain entirely different categories of information. In this situation, the sites can be selected at random system, or selected by the user depending on their interests that day.

Another alternative data delivery engine application downloads the disc's entire content directly to the end user's computer hard drive the first time it is inserted. In the preferred embodiment, the downloaded data is programmed so that the end user may access only part of the encoded content as determined by a 24 hour per day, clock governed schedule. The disc can then be downloaded from the system to release the disc drive for other uses.

A significant advantage provided by the invention is that no computer expertise is necessary to take advantage of the invention. The data delivery engine is extremely user friendly. To use the invention, the user only needs to insert the data delivery engine disc in the appropriate drive, and the data delivery engine does the rest, delivering immediate streaming media content from either the end user's hard drive, or from a distant server at speeds compatible with each sending computer's modem.

While those skilled in the art will recognize that the data delivery engine can be downloaded from an Internet web site, the preferred embodiment envisions that the discs used by the data delivery engine are distributed by large volume distribution, and are not downloaded from the internet. The data delivery engine discs are preferably distributed to consumers either by purchase at retail locations as stand alone products, or as inserts contained in other products. Data delivery engine discs can also be distributed via direct mail or as “e.coupons” contained in other media, such as newspapers, magazines or greeting cards. The provision of customized discs allows the data delivery engine to be produced as a premium item which is given away at no cost and used in conjunction with other marketing efforts.

The consumer advertising, marketing, couponing, sampling, premium and stand alone product applications of the data delivery engine are vast. For example, it is also possible to form the discs in unique shapes, which may enhance the attractiveness of the product uses a premium product, or associate it with a particular company.

The following list describes some of the potential applications for the data delivery engine:

1. Repetitive Premium

One method of utilizing the invention is to encourage repeat sales. For example:

By chance, a driver running low on gas stops at a gas station to purchase a small amount of fuel. In the preferred embodiment, signage at the pump promotes the free availability of the “January Joke of the Day.” The promotion offers a different joke each day for the entire month if the driver purchases a fill-up. Pictures of celebrities pique the consumer's curiosity, and motivate the user to purchase the required fill-up to obtain the data delivery engine disc for January. At home, the consumer inserts the disc into his computer, which either downloads all thirty one, 2-3 minute January video “Jokes of the Day” to his hard drive for subsequent retrieval every 24 hours, or alternatively, the data delivery engine downloads only the daily refreshed URL accessing capability to connect with a distant streaming media server. There, the server's “Joke of the Day” program delivers a different celebrity comic telling a different video joke every day.

In either embodiment, the hard drive stored application or internet delivered application, the consumer can only retrieve a single 2-3 minute joke within each 24 hour period. The previous day's jokes, whether played back or not, are lost to the retrieval process and the end user can never obtain all of a given month's jokes on one day.

It is also possible to generate revenue from the data delivery engine by adding commercials. For example, each joke of the day can be preceded by a short 5-20 second advertisement which can also vary daily.

At the end of January's thirty one days. Whether accessed from the hard drive or delivered by the internet, the jokes are gone. A few days before the end of the month the consumer is reminded that to continue, the consumer must go back to the gas station and purchase another fill-up to obtain February's data delivery engine and next months Jokes of the Day.

Another alternative preferred embodiment allows the user, after hearing a joke, to store the joke for later replay. This allows the user to save items that they find particularly interesting or amusing.

An advantage provided by the data delivery engine discs is that they generate repeat consumer purchases at low premium-to-purchase cost ratios, and then generate additional revenue from the advertising revenues resulting from the advertisements presented by the data delivery engine prior to telling a joke.

2. In-Pack Premium Coupons.

Another embodiment of the invention is to provide premiums for selecting a particular product. For example:

A child accompanies his mother to the supermarket where he sees an advertisement on a cereal box, such as “Spiderman(™) Inside.” Retrieving the data delivery engine Spiderman disc from the box and inserting it into his home computer, the data delivery engine delivers 5-8 minutes of Spiderman video animation and another cereal commercial. In this model, the Spiderman video content, which is licensed by the data delivery engine from the original copyright owner and subsequently sublicensed to other data delivery engine licensees, is self contained on the disc, allowing the child continuous use. Preferably, there would be no need to access a remote computer to download any information. The information would be contained on the premium disc. One week and several plays later, the child consumer and parent are back at the supermarket, where the child selects another cereal box with “Batman(™) Inside.” As any parent will attest, children can be very influential in motivating the parent for purchases of this type. By providing an incentive via the premium data delivery engine disc, the child will have a strong interest in purchasing that particular product. As a result, the premium not only elicits an initial sale, it also can have a strong effect on generating downstream sales.

In an alternative embodiment, when the data delivery engine is installed in the user's system, it brings the child to the cereal manufacturer's internet web site for play back of the same content (non hard drive retrievable). This embodiment provides some additional advantages. For example, in addition to watching a Spiderman or Batman clip, the child can enter a contest or sweepstakes sponsored by the cereal manufacturer with a chance to when additional prizes such as a trip to Disneyland, etc.

3. Stand-Alone Retail Product (Kids)

Kid's data delivery engine discs can also be marketed as a collectible, open ended line of different discs which are contained in one package, and intended to be sold in retail outlets and toy stores. For example, a package of 5-8 discs may be sold at a price range of $4.95 to $5.95. In the preferred embodiment, each package would be gender specific for girls and boys, 6 to 12 years of age. Each data delivery engine disc would contain up to 10 minutes of direct video playback (non-internet delivered). The introductory data delivery engine disc collection would consist of 20 different packages with a total of 100 different first edition data delivery engine discs and would kick off an open ended line of continuously updated products, with new issues continuing from year to year.

An advantage of this method is that a continuing product line greatly appeals to a child's natural trading and collecting instincts, and has been the basis for the success of dozens of toys (e.g. “GI Joe,” “Furbys,” “Hot Wheels,” “Pokemon,” etc.). Data delivery engine discs not only play back video for repetitive enjoyment by the child but each disc can also be programmed to take the child automatically, to the product licensee's own data delivery engine website. There, the toy company's latest and greatest new toy commercials are delivered, or special contests are made available to provide additional play value. Each new purchased data delivery engine disc delivers new internet or hard drive generated streaming video. Data delivery engine kid's applications are a great toy concept for the new generation of computer literate children. All data delivery engine discs are easy to use, portable, collectable, tradable, self-demonstrating to the next buyer, gender neutral, and low cost.

4. Stand Alone Retail Product (Greeting Card)

An individual can send a friend or relative a 365 day reminder of the individual, every day of the year, in a birthday card. Every day, as soon as the recipient turns on his or her computer, the previously installed data delivery engine disc brings up a different Joke of the Day from a famous comedian. For example, on Monday it's Rosie, on Tuesday it's Seinfeld, on Wednesday it's Tim Allen, etc. The data delivery engine provides 365 new faces and new jokes for an entire year. The birthday card recipient just inserts the data delivery engine disc, contained in the card, into the CD or DVD drive of his computer, one time only, which then downloads the data delivery engine's internet auto addressing program to the hard drive, which then delivers a single, 2-3 minute video joke every day of the year, to the card recipient's computer, via a branded Joke of the Day website. Everyday, year-round, the birthday boy or girl gets the greatest gift of all: laughs.

5. Personal messages

An individual for from home, such as a soldier stationed overseas in a combat zone, is quite often unable to contact friends and family. The data delivery engine allows the soldier to merely turn on the computer, which will then use the data delivery engine to automatically download and present a variety of messages from family and friends. An advantage of the data delivery engine is that permits multiple data types to be delivered to the user. This can be an extremely valuable way to improve the morale of troops in the field.

Having presented a general overview of the features and advantages of the invention, a more detailed discussion of the figures will now be presented.

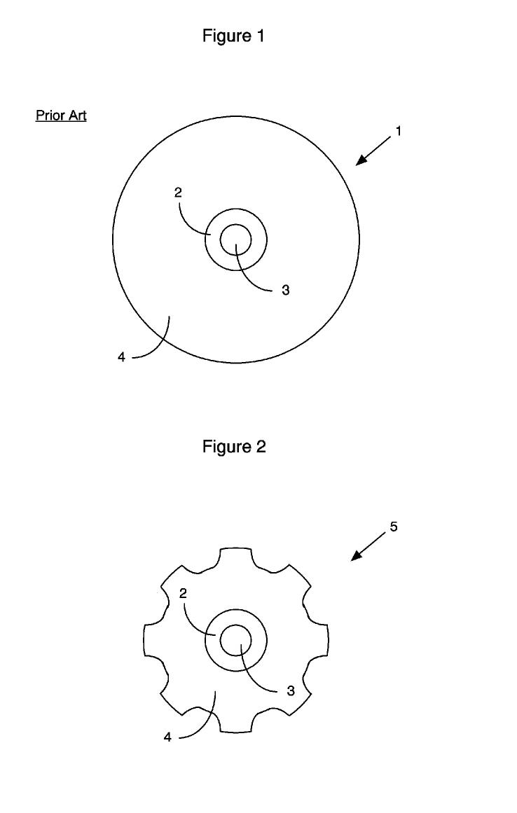

In FIG. 1, a prior art optical disc 1 is shown. Optical disc 1 as a central mounting aperture 3, a clear non-readable peripheral area 2 around the perimeter of the mounting aperture 3, and a read/write area 4 where information is stored. For ease of discussion and illustration, only a single type of prior art storage device is shown. However, those skilled in the art will recognize that the invention can be implemented by any suitable storage device. In the preferred embodiment, it is envisioned that optical discs will be used because of their low cost and large storage capacity. In addition, an optical disc has an additional advantage in that it can take any convenient size. For example, the optical disc 1 shown in FIG. 1 is the conventional size currently used for a wide variety of products. However, the gear-shaped disc 5 shown in FIG. 2, below, illustrates the fact that the disc can not only be made a smaller size, but it can also have an irregular shape for aesthetic purposes. Of course, new types of storage medium are developed periodically, along with improvements with pre-existing storage devices. Any of these devices can be used if suitable for the task, providing that they have suitable storage capacity to hold the required software and data. Likewise, any magnetic storage, solid-state storage, holographic storage, or any other storage medium can be used. The only requirement is that they are capable of being read by the computer, and have sufficient data capacity.

FIG. 2, a uniquely shaped data delivery engine disc 5 is shown. This figure illustrates the fact that the disc 5 having a gear shape for aesthetic reasons. Those skilled in the art will recognize that disc 5 can have any number of shapes so long as it is capable of being read by a disc drive. Further, since disc 5 typically will not require all of the data storage capacity of a prior art CD or DVD drive, it can be made a smaller size which will facilitate packaging, storage, and will also reduce cost.

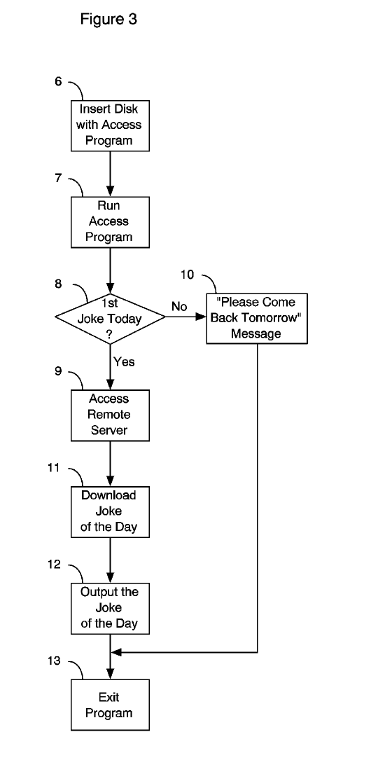

FIG. 3 illustrates a preferred embodiment of the basic data delivery engine which downloads one item of information per day. As discussed above, the user starts the data delivery engine by inserting a disc into the user's computer at step 6. The disc contains the data delivery engine program which will access and output today's joke (or any other predetermined information) to the user.

The data delivery engine program is started at step 7. In the preferred embodiment, the disc contains an autorun file which automatically executes when the disc is loaded, or when the system starts. Of course, an advantage of the autorun feature is that it allows the data delivery engine program to be executed by individuals having almost no knowledge of computers. Alternatively, the user can decide when to execute the data delivery engine program by manually starting it.

When the data delivery engine is started, it first determines if the user has already heard today's Joke of the Day. This is shown at step 8. If the user has heard today's joke, the data delivery engine issues an invitation to come back tomorrow at step 10, and then exits the program at step 13.

On the other hand, if the user has not heard today's Joke of the Day, the data delivery engine accesses a remote server, at step 9. It then downloads the Joke of the Day from the remote server at step 11. Once the joke is downloaded, is output to the user at step 12. Once step 12 is complete, the data delivery engine terminates at step 13.

As noted above, for ease of discussion, the information presented by the data delivery engine has been discussed in terms of jokes. However, those skilled in the art will recognize that any type, or format, of information can be acquired and output by the data delivery engine.

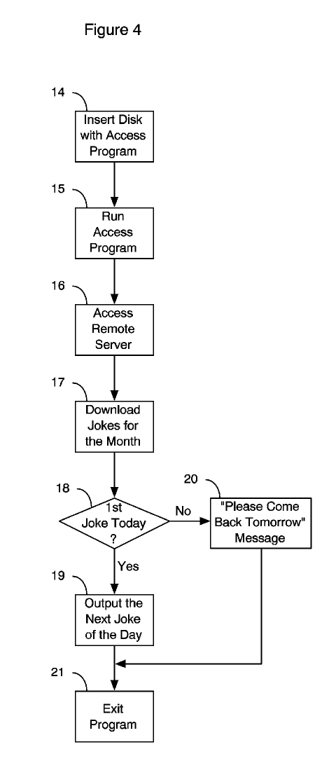

FIG. 4 illustrates an alternative preferred embodiment. In this embodiment, when the disc is inserted into the computer, it downloads an entire month of jokes and stores them on the local computer. The advantage of this embodiment is that the Internet only needs to be accessed once per month.

As shown in FIG. 4, the disc containing the data delivery engine is installed on the user's computer at step 14. The data delivery engine is then started at step 15. As discussed above regard to the previous embodiment, the data delivery engine can be executed via an autorun feature or executed manually. In step 16, the data delivery engine accesses the remote server. Once communications are established with the remote server, an entire month of jokes is downloaded at step 17.

In step 18, the data delivery engine determines if a joke has been delivered that Day. Determining whether or not a joke has been delivered his relatively simple procedure. When the data delivery engine is initially installed, it stores data indicating whether the program has been executed before. In addition, it will also store the last date that a joke was output. Further, the data delivery engine can maintain a list of each joke that was told some that individual jokes repeated. The system and compares the last date a joke was output with the current date on the system clock to determine if a new joke can be told. If not, the “Please Come Back Tomorrow” will be displayed at step 20. Otherwise, the joke will be presented at step 18. After the joke has completed, the data delivery engine terminates at step 20.

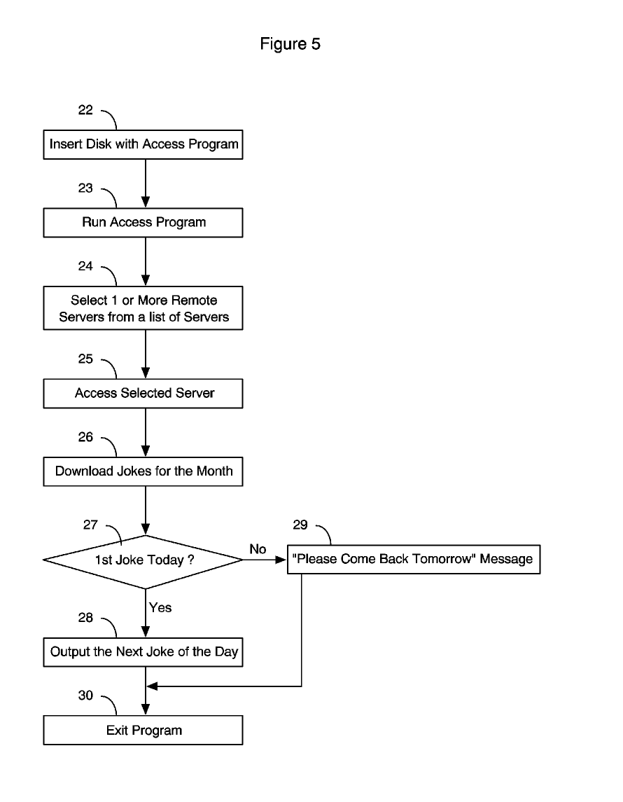

In FIG. 5, another alternative embodiment is illustrated. In this embodiment, the system can access multiple remote servers for different types of data. For example, the data delivery engine may be initialized such that it presents not only one type of subject matter, such as jokes, but also presents other types of data. The system can be arranged so that it presents a variety of information to a user over the course of a day.

As shown in the figure, the data delivery engine disc is inserted into the computer at step 22. At step 23 the data delivery engine program is loaded and executed. Once the program is loaded, it can select data from one or more remote servers at step 24. The list of available servers is preferably on the data delivery engine disc. The servers can contain databases with any type of information. The types of information can be predetermined and stored on the data delivery engine disc, or it can be access from a remote server. Alternatively, the user can be given the option of selecting which databases to use.

Once the appropriate servers are selected, at step 25, the information is presented to the user at steps 27-30 in the same manner that data is presented in the preceding embodiments.

What is claimed is:

1. The method of delivering information using a MiniDisc, including the steps of:
preloading access information onto a disc;
loading the disc into a drive on a local computer that is capable of reading the access information;
accessing a remote computer using the access information;
periodically delivering information from the remote computer for output by the local computer.
